(19) United States
(12) Patent Application Publication
(10) Pub. No.: US 2009/0104811 A1
(43) Pub. Date: Apr. 23, 2009

(54) Extension cord featuring length adjustable ends

(76) Inventor: Wesley K. Sumida, Fair Oaks, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(21) Appl. No.: 11/975,491

(22) Filed: Oct. 18, 2007

(51) Int. Cl. H01R 13/72

(52) U.S. Cl. 439/501

(57) ABSTRACT

An extension cord is provided with a central portion which is uncoiled, this central portion bounded on either end by a first coil and a second coil. Each of these coils are length adjustable while the central portion is substantially non-extendible. The extension cord can be fixed in position at a point along the central portion or routed through a narrow space at the central portion and still facilitate length adjustability at two different locations adjacent ends of the cord. Connectors are provided at ends of the cord. The connectors can be male and female power plug connectors for delivery of electric power or can be data cables or combined data and power cables. For instance, USB extension cords, SCSI extension cords, S-VIDEO extension cords, ethernet extension cords, RCA extension cords and power strip extension cords can provide various different connectors for the length adjustable extension cord of this invention.

### FIELD OF THE INVENTION

The following invention relates to electric extension cords. More particularly, this invention relates to electric extension cords which have a variety of different connectors at ends thereof for either transmitting power, electric signals, or both and which feature at least portions of the cord being coiled for length adjustability.

### BACKGROUND OF THE INVENTION

Most electric equipment is characterized in that it has at least one and often multiple separate electrically conductive cords extending therefrom. These cords can generally be referred to as extension cords and include an electrically conductive path (sometimes a plurality of such paths) surrounded within an insulating jacket. The cords have appropriate connectors at ends thereof for connecting to the electric equipment on one end and to peripheral devices or power supplies at the other end.

For instance, with computer equipment a computer will typically have a power extension cord which provides power to the computer from a standard AC electric power wall jack. The computer will have a separate extension cord extending from the computer to a monitor which at least provides a signal to the monitor and possibly both power and a signal to the monitor. Furthermore, the computer might have an extension cord coupled thereto which connects the computer to a network, such as through an ethernet extension cord. If the computer has an external hard drive or other removable or non-removable media drive, the computer will typically have a USB extension cord or a FIREWIRE extension cord (or perhaps an SCSI extension cord) extending from the computer to such external devices.

These examples are only a small portion of the ever increasing number of external devices and extension cords which are known in the art for removable connection to a computer. Other electric equipment such as stereo equipment similarly often have a variety of different extension cords extending therefrom including speaker wires, connectors to adjacent stereo components and interconnections to networks such as home audio networks.

A common problem associated with this large number of extension cords extending from electric equipment, such as computers, is extension cord management. Having a large number of extension cords extending from a computer can create a variety of problems. The extension cords can be in an unsightly jumble making a work area less attractive. The extension cords can encroach upon work space that might otherwise be utilized in a more productive way. Furthermore, extension cords have a propensity to be either a little bit too short or too long and hence difficult to keep neat and out of the way of a user.

When a cord is too short, the user either must purchase a longer extension cord at additional expense and then dispose of the existing extension cord or move the electric equipment or peripheral devices closer to the computer or other electric equipment to facilitate the connection. This can cause other extension cords to then be too short or otherwise result in a less than optimally oriented work environment.

One partial solution to this problem of cord management is to provide extension cords which are coiled. Coiled extension cords are known in the art and provide a helical pathway for the electrically conductive path between the two connectors of the extension cord. While the cord itself cannot be elongated, by providing it in this coiled configuration, the coil can act somewhat like a helical torsion spring having a bias towards a collapsed shortest length but being length adjustable by providing a slight tension force on the cord between the two connectors at ends of the cords. When this tension force is applied, the turns of the coiled section are caused to be spaced from each other and effectively increase a length between the ends of the extension cord. The result is an extension cord which can be at a precisely desired length without excessive length of extension cord to “manage” and without being as likely to have the extension cord “come up short.”

However, coiled extension cord also have drawbacks. By coiling the extension cord it becomes effectively thicker making it more difficult to route such an extension cord between a back edge of a desk and a wall or cubicle divider, or otherwise routing the extension cord through a small hole passing through a wall, cubicle divider, desk surface or other partition. Furthermore, it is often desirable to attach the extension cords to adjacent surfaces to keep them in a fixed position. With a coiled extension cord, such affixing of the extension cord effectively deactivates portions of the coiled extension cord from being able to function in a length adjustable fashion. Also, fixing of a coiled extension cord is more difficult than a non-coiled extension cord.

Excessive turns of a coiled extension cord can cause undesirable inductance losses in electric signals passing along the extension cord, either degrading power or signal (or both) passing along the cord. Coiled extension cords also have an undesirable propensity to become kinked due to twisting of the ends of the extension cord more or less than optimal for the extension cord. If the extension cord is either over-twisted or under-twisted, the extension cord can develop additional “macro turns” and get tangled with itself as is common with long length coiled extension cords, such as on some telephone handsets. Also, the coiling of the extension cord can lose its tightness over time further leading to a propensity for kinking or development of macro turns or other undesirable effects with the coiled extension cords.

When dealing with cord management issues associated with electric and particularly computer equipment, a great amount of length adjustability is typically not required. Rather, only a small amount of length adjustability can make a big difference in optimally positioning an extension cord. In particular, computers are often positioned at a work station where power is close by and peripheral devices are relatively close by. Extension cords are typically provided in the three to eight foot length range and when they “come up short” it is usually just a couple of feet short of the required length. When the extension cords are excessively long, it is most commonly only by a couple of feet that they are excessively long.

Furthermore, the cord is often routed over a back/edge of a desk or through a hole in a desk which is a relatively small space and where it is generally desirable to prevent the extension cords from moving once installed through this hole or back edge of the desk; and often cord fixation occurs at these locations. Hence, a need exists primarily for providing a small amount of length adjustability on an end of the extension cord close to the computer or other electrically conductive equipment and at an end of the extension cord where the extension cord connects to a power source or to peripheral equipment, but without excessive amounts of length adjustability and corresponding difficulties.

### SUMMARY OF THE INVENTION

With this invention, an extension cord is provided which features length adjustable portions at ends of the extension cord, but which is non-length adjustable at a central portion. With such a configuration, the extension cord can be conveniently fixed from length extension or linear motion at a middle portion thereof, and yet can be readily length adjusted at each end thereof for optimal length to be provided on the extension cord adjacent each end of the extension cord, for optimal cord management.

In particular, the extension cord of this invention includes a first connector at a first end and a second connector at a second end. The connectors can be identical or complemental or otherwise configured to handle the particular electric signal to be transmitted. The cord extends from the first connector to the second connector with an electrically conductive path therein. The cord has at least three sections including a central cable which is uncoiled and a first coil adjacent the first connector and a second coil adjacent the second connector. The two coils define regions of the cord which are length adjustable. The central cable is characterized by being non-length adjustable.

With such an overall configuration, the central cable portion of the extension cord can be fixed to a support structure, routed through a small hole in a desk surface or cubicle wall or other partition, or routed behind a back edge of a desk against a wall or other partition with minimal space being required. However, ends of the extension cord close to the first connector and the second connector can each be length adjusted through the first coil and the second coil, to provide optimal length for connection to a computer or other electrically conductive equipment. The resulting extension cord, once deployed, avoids tangles, excessive cord length, “coming up short” and otherwise provides for optimal cord management to maximize utility of the work space.

Any electric extension cords and associated connectors known in the art can conceivably be utilized according to this invention to provide the connectors for the cord. Such cords include male and female power plugs of a power extension cord, USB connectors, SCSI connectors, S-VIDEO connectors, FIREWIRE connectors, ethernet connectors, telephone connectors, RCA jack connectors and any other connectors for transmitting of an electric signal along an extension cord of a type either now in existence or in the future developed.

In one form of the invention the extension cord is configured as a power cord with a male connector plug provided as the first connector and with a power strip provided as the second connector with a plurality of female receptacles therein. Optionally a switch and light are provided for disabling of the power strip and for indicating the status of the power strip. This embodiment facilitates the connection of a variety of different electrically powered appliances to the power strip and provides for optimal cord management between the male plug connector and the power strip according to this invention.

### OBJECTS OF THE INVENTION

Accordingly, a primary object of the present invention is to provide an extension cord which is length adjustable at each end of the extension cord and non-length adjustable at a central portion thereof for optimal cord management characteristics.

Another object of the present invention is to provide an extension cord which can provide electric power or an electric signal (or both) between an electrically conductive equipment item and a source of power or peripheral equipment.

Another object of the present invention is to provide an extension cord which is length adjustable but avoids kinking.

Another object of the present invention is to provide an extension cord which is length adjustable and can still be readily routed through small spaces.

Another object of the present invention is to provide an extension cord which is length adjustable and can still be readily affixed at a central portion thereof to adjacent structures and still exhibit length adjustability on both sides of an affixation point.

Other further objects of the present invention will become apparent from a careful reading of the included drawing figures, the claims and detailed description of the invention.

### BRIEF DESCRIPTION OF THE DRAWINGS

FIG. 1 is a perspective view of the extension cord of this invention shown in a first power cord embodiment. In each of the figures a central cable portion of the extension cord is cut away to allow end portions of the extension cord to be magnified, with cut away portions constituting a length of non-coiled cable similar to portions of the cable shown adjacent the portions cut away, with cut away portions representing a variable amount of cut away cord.

FIG. 2 is a top plan view of that which is shown in FIG. 1.

FIG. 3 is a side elevation view of that which is shown in FIG. 1.

FIG. 4 is a bottom plan view of that which is shown in FIG. 1.

FIG. 5 is a side elevation view of that which is shown in FIG. 1 and inverted relative to its appearance in FIG. 3.

FIG. 6 is an end elevation view of a portion of that which is shown in FIG. 3 in section along lines 6-6 of FIG. 3.

FIG. 7 is a perspective view of an alternative embodiment of that which is shown in FIG. 1, featuring USB connectors at ends thereof.

FIG. 8 is a perspective view of an alternative embodiment of that which is shown in FIG. 1, featuring SCSI connectors at ends thereof.

FIG. 9 is a perspective view of an alternative embodiment of that which is shown in FIG. 1, featuring S-VIDEO connectors at ends thereof.

FIG. 10 is a perspective view of an alternative embodiment of that which is shown in FIG. 1, featuring ethernet connectors at ends thereof.

FIG. 11 is a perspective view of an alternative embodiment of that which is shown in FIG. 1, featuring RCA connectors at ends thereof.

FIGS. 12A and 12B are perspective views of an alternative embodiment of that which is shown in FIG. 1 where the female connector is replaced with a power strip.

FIGS. 13A and 13B are perspective views of that which is shown in FIG. 1 with the coiled sections adjusted to a greater length upon applying a tension force to the extension cord for length adjustability.

### DESCRIPTION OF THE PREFERRED EMBODIMENTS

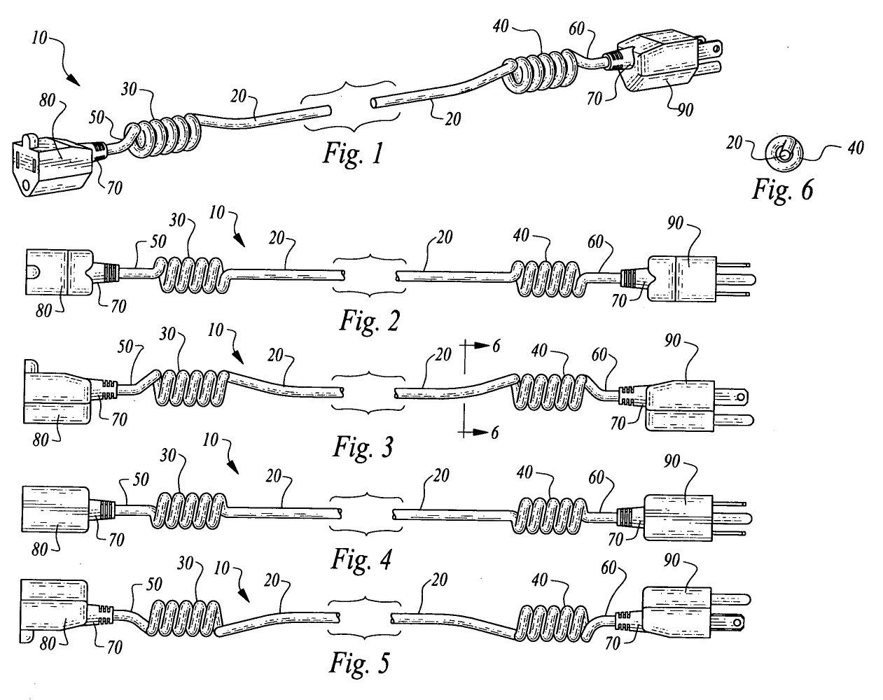

Referring to the drawings, wherein like reference numerals represent like parts throughout the various drawing figures, reference numeral 10 is directed to an extension cord (FIG. 1) featuring length adjustable ends. Coiled sections including a first coil 30 and second coil 40 are provided adjacent each of the ends of the extension cord 10. These coiled sections can be extended linearly (FIGS. 13A and 13B) to increase a length of the extension cord at these locations. In this way, the extension cord 10 can be fixed in position along a central cable 20 between the first coil 30 and second coil 40 and be conveniently extended a small amount adjacent each end of the extension cord, to allow the extension cord 10 to reach adjacent electric equipment or other devices to be connected without excessive slack and minimizing the potential need to move electric equipment to a non-optimal position.

In essence, and with particular reference to FIG. 1, basic details of the extension cord 10 are described according to this preferred embodiment. The extension cord 10 includes a cable extending between ends of the extension cord 10. This cable includes a central portion 20 with a first coil 30 adjacent one end of the central portion 20 and a second coil 40 adjacent the central portion 20 and on an end of the central portion 20 opposite the first coil 30. The cable also preferably includes a first stub 50 on a side of the first coil 30 opposite the central portion 20 and a second stub 60 on a side of the second coil 40 opposite the central portion 20. Preferably, strain reliefs 70 are provided on ends of the stubs 50, 60 most distinct from the central portion 20. These strain reliefs 70 are at a location where ends of the cable are joined to a female connector 80 or a male connector 90 in this preferred embodiment. The extension cord 10 thus has two separate regions which exhibit length adjustability, with a majority of the cable preferably included within the central portion 20 so that the central portion 20 can be affixed to adjacent support structures or routed through tight spaces at a variety of different positions along the central portion 20 and still provide an extension cord 10 which can be length adjusted between such a capture point on the extension cord and ends of the extension cord including the female connector 80 and male connector 90 thereon.

More specifically, and with particular reference to FIGS. 1-6, details of the cable are described. The cable 20 is generally defined as all portions of the extension cord 10 other than the strain reliefs 70 and the connectors, such as the female connector 80 and male connector 90. The cable 20 includes at least one electrically conductive pathway surrounded by an insulating jacket in the preferred embodiment. While the insulating jacking is not strictly required, it is typically provided on such extension cords as the extension cord 10 of the preferred embodiment.

The electrically conductive pathway could be a single pathway, but most preferably is multiple electrically conductive pathways bundled together and typically insulated from each other within the exterior insulating jacket. For instance, in this most preferred embodiment where the cable is provided on a power extension cord 10, three separate electrically conductive pathways (typically copper wire) are provided including a positive pathway, a negative pathway and a ground pathway. Each of these pathways would typically be in electric contact with one of the prongs on the male connector 90 and with electrically conductive structures within holes formed in the female connector 80. In alternative embodiments, a greater or lesser number of electrically conductive pathways can be provided along the cable following the technical specifications for the particular cable involved.

With continuing reference to FIGS. 1-6, details of the central portion 20 of the cable 20 are described. The cable 20 includes a central portion which is uncoiled and preferably provides a majority of an overall length of the extension cord 10 both when the extension cord 10 is in a relaxed shortest configuration and in a length adjusted position to a maximum length. The cable along the central portion 20 is flexible but substantially inelastic in an elongate direction, such that a length of the central portion 20 of the cable cannot be appreciably increased or decreased.

As one non-limiting example, an overall extension cord can be provided which is six feet long before any elongation. With three inches provided for each stub 50, 60 and each connector 80, 90 and three inches provided for each coil 30, 40, five feet of cable remain for the central portion 20 of the extension cord 10. In a second embodiment, the stubs 50, 60 and connectors 80, 90 can take up six inches each of length and the coils 30, 40 can each take up six inches length, such that four feet of the cable remain within the central portion 20 of the extension cord 10.

If desired, the central portion 20 could be shorter. Most preferably, central portion 20 would only be shorter in shorter extension cords, such as perhaps a three foot extension cord where the central portion 20 could be two feet long and with three inches for each of the coils 30, 40 and three inches for the stub 50, 60 and connector 80, 90 combinations at each end of the extension cord 10. It is also conceivable that the central portion 20 could provide less than a majority of an overall length of the extension cord 10. Furthermore, longer embodiments than those described by example above could also be provided.

In the embodiment shown, the central portion 20 of the cable has an approximately one-eighth inch diameter. Such a diameter is most typical but could be increased or decreased to suit the particular cable specifications to be matched. In each of the figures the central portion 20 is broken at a midpoint thereof. Parts of the central portion 20 which have been cut away are preferably identical to portions of the central portion 20 which are shown in the figures in a most preferred form of the invention.

The central portion 20 importantly defines a portion of the extension cord 10 which is available for either capture or routing through an exceptionally tight space (or both). For instance, various different extension cord fixation devices known in the art can be effectively utilized somewhere along the central portion 20 to affix the extension cord 10 either permanently or temporarily to adjacent structures. The extension cord 10 can still be length adjusted on either end of such a fixation point along a central portion 20 for maximum convenience and utilization of the extension cord 10. When the extension cord 10 needs to be routed between a back edge of a desk and a wall or other vertical panel, central portion 20 can be provided for routing through this tight space so that the desk need only be spaced from such a vertical wall by one-eighth of an inch to allow the central portion 20 of the cable to be passed by. Also, when holes are provided through a desktop surface or through adjacent walls or panels through which an extension cord must pass, the central portion 20 is conveniently provided as an exceptionally small cross-section portion of the extension cord 10 which can pass through this tight point. On either side of this constriction where the central portion 20 is routed, the extension cord 10 can still exhibit length adjustability through either the first coil 30 or the second coil 40.

With continuing reference to FIGS. 1-6, details of the coils 30, 40 are described. With this invention two separate coils are provided including a first coil 30 and a second coil 40 as a portion of the cable 20. These coils 30, 40 are provided on opposite ends of the central portion 20. Most preferably, the first coil 30 and second coil 40 are identical in size, shape and overall configuration. Each coil 30, 40 preferably is formed of portions of the cable which are similar to the central portion 20 except that the coils 30, 40 exhibit a helical form. The cable forms the coils 30, 40 by being curved into a series of adjacent turns. Most preferably, five turns are provided with each turn having a diameter of about four times the diameter of the cable itself. Hence, where the coils 30, 40 are provided, the extension cord 10 exhibits an approximately half inch diameter.

With the preferred number of five turns for the coils 30, 40 only a relatively small overall portion of the extension cord 10 is provided with a coiled form. Hence, a propensity for kinking, tangling or other negative attributes associated with long coiled extension cords (i.e. telephone handset extension cords) are largely avoided. Most preferably, the coils 30, 40 are sufficiently tight so that the turns in the coils 30, 40 are adjacent each other and touching each other when the coils 30, 40 are in a relaxed shortest configuration. When the coils 30, 40 are stretched (FIGS. 13A and 13B), such as by applying a tension load along a long axis of the extension cord 10, the coils 30, 40 preferably relatively easily provide for a four times increase in length. Thus, a one and a quarter inch long coil 30, 40 can be elongated to four to five inches quite readily, so that close to a foot of overall length adjustment can be provided for the extension cord. In this way, an extension cord 10 which is six feet in length when in a relaxed shortest form can be relatively easily stretched to approximately a seven foot form. While such elongation is considered optimal, a potentially greater amount than four times length increase could be provided or the coils could be restricted to less length adjustability, such as by increasing or decreasing the number of turns in the coils 30, 40 or by changing the radius of curvature of the coils 30, 40.

Materials forming the cable including the insulating jacket and the electrically conductive pathway therein help to define an amount of force required to elongate the cable at the coils 30, 40. Most preferably, materials are selected and sized so that the coils 30, 40 exhibit sufficient resistance to elongation that when unloaded will cause the coils 30, 40 to return to an original position with the turns of the coils 30, 40 adjacent each other, but without significant additional force beyond a force necessary for such return to an original state with the turns touching each other. Most preferably, no more than five pounds of tension load need be applied between the central portion 20 and one of the connectors 80, 90 to cause the coils 30, 40 to reach a maximum extension of approximately four times an original length. Such force characteristics for the coils 30, 40 and general spring-like characteristics for the coils 30, 40 can be adjusted to meet the design criteria desired.

With continuing reference to FIGS. 1-6, details of the first stub 50 and second stub 60 are described. The stubs 50, 60 are preferably similar to a central portion 20 of the cable and define portions of the cable which are not coiled and which provide a transition from the coils 30, 40 to the connectors 80, 90. It is conceivable that the coils 30, 40 could connect directly to the connectors 80, 90 without providing the stubs 50, 60 at all. The stubs 50, 60 desirably space the coils 30, 40 slightly away from the connectors 80, 90 and electrically conductive equipment to which the connectors 80, 90 attach. Thus, the added bulk associated with the coils 30, 40 are prevented from interfering with operation of the peripherals by providing this short stub 50, 60 spacing the coils 30, 40 away from the connectors 80, 90. Most preferably, this stub 50, 60 length is no more than an inch and most preferably about one quarter inch.

With particular reference to FIGS. 1-5 details of the strain reliefs 70 and connectors 80, 90 are described. Strain reliefs 70 are coupled to ends of the stubs 50, 60 most distant from the central portion 20. These strain reliefs 70 are also affixed to connectors 80, 90 such as the female connector 80 and the male connector 90. Strain reliefs 70 help to absorb stresses that might occur linearly along the extension cord between the cable and the connectors 80, 90 which might tend to cause damage to the cable or the connectors 80, 90 or cause separation of the connectors 80, 90 from the cable 20, leading to a potentially dangerous situation. Strain reliefs 70 can be incorporated into the connectors 80, 90 or could be omitted where they are not deemed necessary for proper functioning of the extension cords 10.

Female connector 80 is preferably a standard female power plug with three holes suitable for receiving prongs from a male connector 90. Female connector 80 can alternatively have other configurations suitable for providing a female end of an electric power extension cord. Female connector 80 is provided to be complemental with the male connector 90 but would typically not be coupled directly to the male connector 90 of the extension cord 10, but rather would be provided to interface with a separate component having a male connector similar to the male connector 90 of the extension cord 10.

The male connector 90 is preferably a standard male plug for an electric power extension cord. The male connector 90 thus includes three prongs including a ground prong, a positive prong and a negative prong. These prongs are adapted to fit within a power receptacle of an electric power system within a structure, or to coupled to a female receptacle such as that provided on a power strip in communication with the electric power distribution system of the building, structure or other location where the extension cord 10 is to be utilized. The male connector 90 is coupled to an input for power into the extension cord 10 and the female connector 80 is configured as an output for delivery of electric power out of the extension cord 10 and into an associated electric power utilizing appliance such as a computer or other electronic equipment.

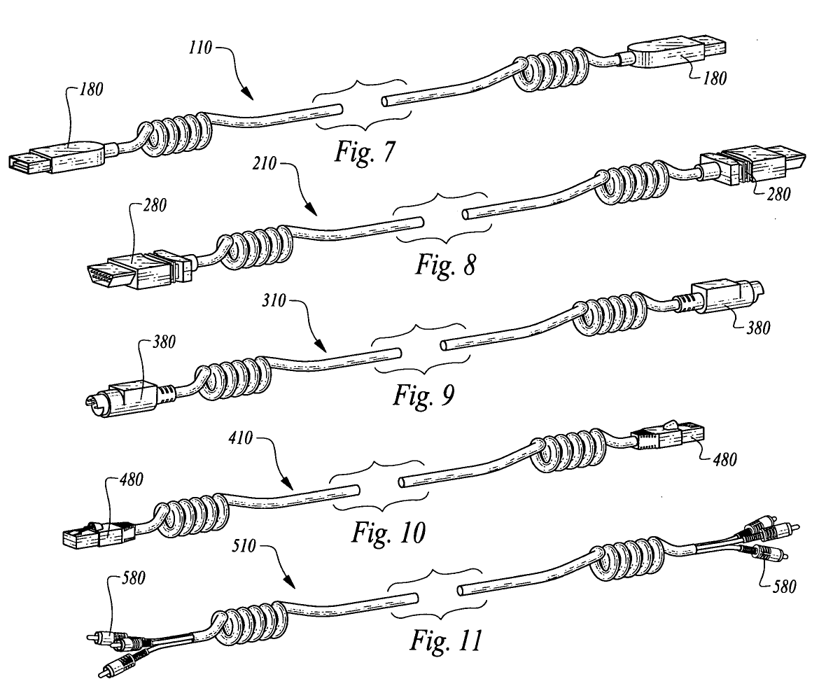

With particular reference to FIGS. 7-12B, details of various different alternative embodiments of the extension cord 10 are described. Each of these alternative embodiments is similar to the preferred embodiment except that different connectors are provided at ends of the extension cord 10 and the cables are modified to transport the signal/power specified for the particular type of cable. In FIG. 7 a USB extension cord 110 is shown. This USB extension cord 110 includes USB connectors 180 at ends thereof. These USB connectors 180 are preferably similar to each other and can be one of a variety of different types of standard USB connectors. As an alternative, the USB connectors 180 could be different from each other rather than identical and be of complemental form or non-complemental form, depending on the particular performance required for the USB extension cord 110.

In FIG. 8 an SCSI extension cord 210 is shown. The SCSI extension cord 210 includes SCSI connectors 280 at ends thereof which are preferably identical to each other and suitable for interfacing with other SCSI devices.

FIG. 9 shows an S-VIDEO extension cord 310 featuring S-VIDEO connectors 380 at ends thereof. FIG. 10 shows an ethernet extension cord 410 featuring ethernet connectors 480 at ends thereof. FIG. 11 shows an RCA extension cord 510 featuring three RCA jacks and RCA connector 580 at each end of the RCA extension cord 510. Each of these extension cords 110, 210, 310, 410, 510 is shown with connectors 180, 280, 380, 480, 580 which are similar at each end of the extension cord 110, 210, 310, 410, 510. Such an arrangement can be provided or as an alternative complemental forms of these connectors can be substituted at either end of the extension cords 110, 210, 310, 410, 510.

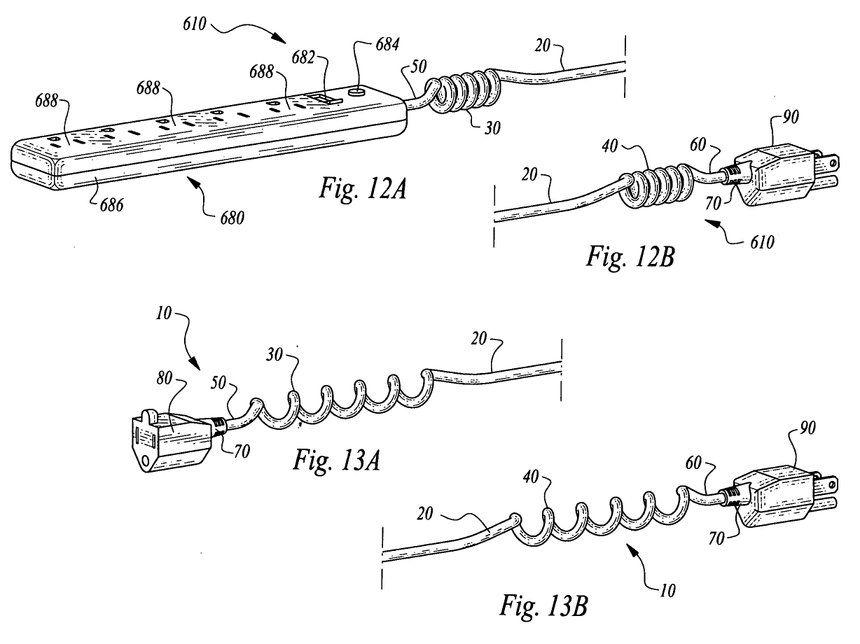

FIGS. 12A and 12B show a power strip extension cord 610 of similar form to the extension cord 10 of the preferred embodiment. A male connector 90 is shown at one end of the power strip extension cord 610 similar to the male connector 90 on the extension cord 10 of the preferred embodiment. However, the female connector 80 is replaced in this power strip extension cord embodiment 610 with a power strip 680. The power strip 680 includes a switch 682 which can selectively connect and disconnect the power strip 680 to the male connector 90 on the power strip extension cord 610. A light 684 is coupled to the power strip 680 in a manner which causes the light 684 to be illuminated when the power strip 680 is active with the switch closed, and the light 684 is darkened when the power strip 680 is deactivated by opening of the switch 682. The power strip 680 includes a housing 686 which includes a plurality of receptacles 688 therein, each of the receptacles 688 having multiple openings for receipt of a separate male connector therein.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When parts of this invention are identified as coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1: An extension cord comprising in combination:
a first connector adapted to connect to an input;
a second connector adapted to connect to an output;
a cable extending from said first connector to said second connector;
said cable having at least one electrically conductive path extending from said first connector to said second connector;
said cable having a central uncoiled section between said first connector and said second connector;
said cable having a first coiled section between said uncoiled section and said first connector; and
said cable having a second coiled section between said uncoiled section and said second connector.

2: The extension cord of claim 1 wherein said first connector is a male power plug with at least two prongs extending therefrom.

3: The extension cord of claim 2 wherein said second connector is a female power plug with at least two holes adapted to receive prongs of a male power plug therein.

4: The extension cord of claim 2 wherein said second connector includes a power strip with a plurality of female power receptacles therein.

5: The extension cord of claim 4 wherein said power strip includes a switch, said switch adapted to selectively couple and decouple said receptacles to said at least one electrically conductive path within said cable.

6: The extension cord of claim 5 wherein said power strip includes a light therein, said light illuminated when said switch is closed and not illuminated when said switch is open.

7: The extension cord of claim 1 wherein a stub is interposed between said first coiled section and said first connector and a stub is interposed between said second coiled section and said second connector, each said stub in the form of an uncoiled section of cable.

8: The extension cord of claim 1 wherein said first connector and said second connector are USB plugs and said cable is a USB cable.

9: The extension cord of claim 1 wherein said first connector and said second connector are SCSI plugs and said cable is an SCSI cable.

10: The extension cord of claim 1 wherein said first connector and said second connector are S-VIDEO plugs and said cable is an S-VIDEO cable.

11: The extension cord of claim 1 wherein said first connector and said second connector are ETHERNET plugs and said cable is an ETHERNET cable.

12: The extension cord of claim 1 wherein said first connector and said second connector are a plurality of RCA plugs and said cable is a plurality of RCA conductive pathways within said cable.

13: The extension cord of claim 12 wherein said plurality of RCA plugs includes three RCA plugs with each of said plugs coupled to a separate electrically conductive path passing along said cable from said first connector to said second connector.

14: The extension cord of claim 1 wherein each of said coiled sections has a stretched length of between one inch and twelve inches.

15: The extension cord of claim 14 wherein each of said coiled sections has a stretched length of between three inches and seven inches.

16: The extension cord of claim 15 wherein said first connector and said second connector are spaced apart by a distance of approximately six feet when said coiled sections are unstretched and a distance of between six and a half and seven feet when said coiled sections are stretched.

17: An extension cord comprising in combination:
a first connector adapted to connect to an input;
a second connector adapted to connect to an output;
a cable extending from said first connector to said second connector; and
said cable having a pair of coiled sections spaced apart by an uncoiled section.

18: The extension cord of claim 17 wherein a majority of length of said cable is uncoiled when said coiled sections are unstretched.

19: A variable length electric cord, comprising in combination:
an elongate electrically conductive path having ends adapted to be electrically connected to adjacent electrically conductive equipment;
two portions of said path being coiled; and
an uncoiled portion between said at least two coiled portions.

20: The electric cord of claim 19 wherein said path has a length of approximately six feet when said coiled portions are unstretched and between six and a half and seven feet when said coiled portions are stretched.
